(19) United States
(12) Patent Application Publication
(10) Pub. No.: US 2017/0008392 A1
(43) Pub. Date: Jan. 12, 2017

(54) FUEL SUPPLY APPARATUS

(71) Applicant: TOYODA GOSEI CO., LTD., Kiyosu-shi (JP)

(72) Inventors: Atsushi SEKIHARA, Kiyosu-shi (JP); Yoshinari HIRAMATSU, Kiyosu-shi (JP); Satoshi SUZUKI, Kiyosu-shi (JP)

(21) Appl. No.: 15/194,872

(22) Filed: Jun. 28, 2016

(30) Foreign Application Priority Data
Jul. 6, 2015 (JP) 2015-135197
May 30, 2016 (JP) 2016-107098

(51) Int. Cl. B60K 15/04; B60K 15/077

(52) U.S. Cl. CPC B60K 15/0403; B60K 15/077; B60K 2015/047

(57) ABSTRACT

A fuel supply apparatus is configured to feed a fuel supplied from a filler port through a filler file to a fuel tank. A grid member that is configured to allow for insertion into a fuel passage formed by the filler pipe and move along the fuel passage and serve to prevent suction of the fuel is held at a placement site in the filler pipe. The placement site is provided at a higher position in a vertical direction than a liquid level of the fuel in the filler pipe. This configuration enhances the effectiveness for preventing suction of the fuel from the filler pipe.

### CROSS-REFERENCE TO RELATED APPLICATION

The present application claims priority to Japanese patent applications No. 2015-135197 filed on Jul. 6, 2015 and No. 2016-107098 filed on May 30, 2016, the contents of which are hereby incorporated by reference into this application.

### BACKGROUND

Technical Field

The invention relates to a fuel supply apparatus.

Description of the Related Art

The fuel supply apparatus is configured to feed a fuel supplied from a filler pipe to a fuel tank by a filler pipe. The filler port is generally closed by a lid but may be subjected to illegal behaviors that insert a small-diameter tube from the filler port into the filler pipe after detachment of the lid and suck the fuel by means of the small-diameter tube. A configuration of the fuel supply apparatus proposed to deal with such an illegal behavior provides a grid member in the neighborhood of a connecting position where the fuel tank is connected with the filler pipe (for example, JP 2014-19413A).

The fuel supply apparatus described in JP 2014-19413A prevents the small-diameter tube from being inserted beyond the grid member and thereby advantageously prevents the fuel in the fuel tank from being directly sucked by the small-diameter tube. The route path from the filler port of the fuel to the fuel tank and the combination of respective components constituting a fuel passage differ depending on, for example, the design of the vehicle, the arrangement of peripheral devices of the fuel tank and the position of the filler port. In some cases, there may thus be a difficulty in providing a fuel suction-preventing member such as a grid member in the neighborhood of the connecting position where the fuel tank is connected with the filler pipe. There is accordingly a need for enhancing the flexibility of arrangement of the fuel suction-preventing member.

### SUMMARY

In order to solve at least part of the problems described above, the invention may be implemented by aspects described below.

(1) According to one aspect of the invention, there is provided a fuel supply apparatus. This fuel supply apparatus comprises a filler pipe configured to feed a fuel supplied from a filler port to a fuel tank the filler pipe forming a fuel passage; and a suction-preventing member held at a placement site in the middle of the fuel passage, the suction-preventing member configured to prevent suction of the fuel. The suction-preventing member is in a shape that allows for insertion from the filler port along the fuel passage to the placement site.

In the fuel supply apparatus of this aspect, the suction-preventing member that is to be held at the placement site is formed in the shape that allows for insertion of the suction-preventing member from the filler port to the placement site. The placement site may be determined according to the convenience, for example, the design of the vehicle and the arrangement of peripheral devices of the fuel tank. In the fuel supply apparatus of this aspect, the suction-preventing member may thus be placed with high flexibility at the placement site in the middle of the fuel passage. The configuration of the fuel supply apparatus of this aspect enables the suction-preventing member to be held at the placement site after being inserted from the filler port to the placement site. There is accordingly no need to part the filler pipe into sections for the purpose of holding the suction-preventing member at the placement site. Additionally there is no need for any additional tubes used for pipe connection at the locations of partition of the filler pipe. The fuel supply apparatus of this aspect accordingly has no need for connection of the parted sections of the filer pipe using additional tubes and assembly of the suction-preventing member. This reduces the man hour.

(2) In the fuel supply apparatus of the above aspect, the placement site may be provided at a higher position in a vertical direction than a ceiling wall of the fuel tank. This configuration has the following advantages. The placement site at the suction-preventing member is held is located at the higher position in the vertical direction than the ceiling wall of the fuel tank. Even when the fuel tank is filled with the fuel, the fuel accordingly does not reach the placement site in the fuel passage. In the fuel supply apparatus of this aspect, even when a tube is inserted into the filler pipe for suction of the fuel, the suction-preventing member held at the placement site effectively prevents the tube from reaching the fuel in the fuel passage. This accordingly prevents suction of the fuel with high effectiveness.

(3) In the fuel supply apparatus of the above aspect, the suction-preventing member may be engaged with an engagement portion provided in the fuel passage at the placement site. This configuration desirably enhances the effectiveness for holding the suction-preventing member at the placement site.

(4) In the fuel supply apparatus of the above aspect, the filler pipe may include the engagement portion at the placement site as a diameter-expanding portion of the fuel passage, and the suction-preventing member configured to be expandable and contractable may be inserted in a diameter-contracted state from the filler port to the placement site and may be expanded after insertion to the engagement portion to be engaged with the engagement portion. This configuration enables the suction-preventing member to be more firmly held at the placement site.

(5) In the fuel supply apparatus of the above aspect, the suction-preventing member may be engaged with the engagement portion and may be thermally welded to the filler piper. This configuration also enables the suction-preventing member to be more firmly held at the placement site.

(6) In the fuel supply apparatus of any of the above aspects, the suction-preventing member may be a grid member that is configured to divide and form a plurality of openings in a grid-like pattern. In the fuel supply apparatus of this aspect, each of the plurality of openings divided and formed in the grid-like pattern has a smaller size than the size of a tube inserted into the filler pipe for suction of the fuel. This configuration thus readily and effectively prevents suction of the fuel.

(7) According to another aspect of the invention, there is provided a manufacturing method of a filler pipe that is configured to feed a fuel supplied from a filler port to a fuel tank. This manufacturing method of the filler pipe comprises (a) providing a suction-preventing member that is placed in a fuel passage formed by the filler pipe and is configured to prevent suction of the fuel, in such a shape that allows for insertion from the filler port to a placement site in the middle of the fuel passage; (b) inserting the provided suction-preventing member into the fuel passage of the filler pipe provided in a straight shape; (c) moving the inserted suction-preventing member along the fuel passage of the filler pipe in the straight shape and holding the suction-preventing member in the fuel passage at a predetermined holding site; and a process of bending the filler pipe in the straight shape with the suction-preventing member held therein to provide the fuel passage along a predetermined route path from the fuel tank. The (c) comprises providing the holding site in the filler pipe in the straight shape, as the placement site in a state that the bent filler pipe is mounted to the fuel tank along the predetermined route path, and holding the suction-preventing member in the fuel passage at the holding site provided as the placement site.

In the manufacturing method of the filler pipe according to this aspect, the straight filler pipe may be used for insertion of the suction-preventing member and move of the suction preventing member along the fuel passage. This configuration enhances the workability with regard to the operation for holding the suction-preventing member in the process of manufacturing the filler pipe. This accordingly reduces the man hour and also reduces the cost.

(8) In the manufacturing method of the filler pipe according to the above aspect, the (c) may comprise providing the holding site in the filler pipe in the straight shape, as the placement site that is located at a higher position in a vertical direction than a ceiling wall of the fuel tank in the state that the bent filler pipe is mounted to the fuel tank along the predetermined route path. In the manufacturing method of this aspect, the straight filler pipe may be used for insertion of the suction-preventing member and move of the suction preventing member along the fuel passage. This configuration enhances the workability with regard to the operation for holding the suction-preventing member in the process of manufacturing the filler pipe having the high effect of preventing suction of the fuel. This accordingly reduces the man hour and also reduces the cost.

### BRIEF DESCRIPTION OF THE DRAWINGS

FIG. 1 is a diagram illustrating the schematic configuration of a fuel supply apparatus to supply a fuel to a fuel tank of a motor vehicle;

FIG. 2 is a diagram illustrating a sectional view in the vertical direction of a filler pipe of a first embodiment in a peripheral area of a placement site and a plan view of a grid member held in the placement site;

FIG. 3 is a diagram illustrating the shape of the grid member prior to assembly and the state of assembly;

FIG. 4 is a diagram illustrating a procedure of insertion of the grid member into the filler pipe;

FIG. 5 is a diagram illustrating a sectional view in the vertical direction of a filler pipe of a second embodiment in the peripheral area of the placement site and a plan view of a grid member held in the placement site;

FIG. 6 is a diagram illustrating the shape of the grid member prior to assembly and the state of assembly;

FIG. 7 is a diagram illustrating the shape of a grid member prior to assembly and the state of assembly according to a third embodiment;

FIG. 8 is a diagram illustrating the shape of a grid member prior to assembly and the state of assembly according to a fourth embodiment;

FIG. 9 is a plan view schematically illustrating a grid member provided as a suction-preventing member in a spiral shape according to a modification;

FIG. 10 is a diagram illustrating another grid member prior to assembly that employs a different configuration for engagement at a placement site and the state of assembly according to a modification;

FIG. 11 is a diagram illustrating engagement of the grid member at the placement site after bending a filler pipe;

FIG. 12 is a perspective view illustrating a grid member prior to assembly according to a first modification;

FIG. 13 is a diagram illustrating a plan view of the grid member shown in FIG. 12;

FIG. 14 s a diagram illustrating a sectional view of the grid member taken along a bending line A-A of FIG. 13;

FIG. 15 is a diagram illustrating the shape of the grid member prior to assembly and the state of assembly;

FIG. 16 is a perspective view illustrating a suction-preventing member prior to assembly according to a second modification;

FIG. 17 is a diagram illustrating a plan view of the suction-preventing member prior to assembly;

FIG. 18 is a perspective view illustrating a grid member prior to assembly according to a third modification; and

FIG. 19 is a diagram illustrating a plan view of the grid member prior to assembly.

### DESCRIPTION OF THE EMBODIMENTS

### A. First Embodiment

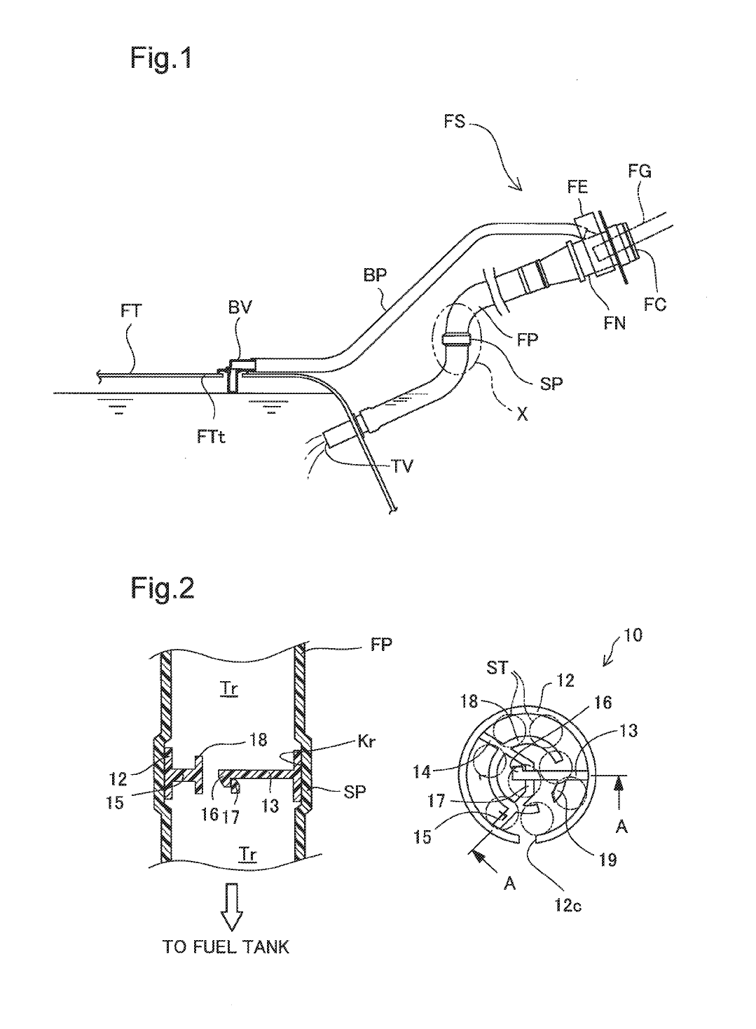

FIG. 1 is a diagram illustrating the schematic configuration of a fuel supply apparatus FS to supply a fuel to a fuel tank FT of a motor vehicle. The fuel supply apparatus FS includes a filler neck FN, a filler pipe FP according to a first embodiment, a check valve TV, a breather pipe BP, a gas release regulating valve RV and a mounting member FE. The filler neck FN is fixed to a fuel supply part (not shown) of the vehicle by the mounting member FE and serves to receive a fuel gun FG that is inserted into a filler port FC. This filler neck FN is connected with the fuel tank FT by the filler pipe FP and the breather pipe BP. The filler pipe FP is a resin tube having oil resistance and is configured to feed the fuel supplied from the filler port IT into the fuel tank FT. The filler pipe FP is bent in advance to form a fuel passage along a predetermined route path from the fuel tank FT and to be connected with the filler neck FN. The bent filler pipe FP is held on the vehicle at appropriate locations in the middle of the route path by means of metal fittings (not shown) or the like and is mounted to the fuel tank FT. In the state that the filler pipe FP is mounted to the fuel tank FT along the predetermined route path, the filler pipe FP is extendable and bendable in some range. Additionally, the filler pipe FP has a diameter-expanded placement site SP in the middle of the pipe at a higher position in the vertical direction than a ceiling wall FTt of the fuel tank FT. A grid member 10 described later is held in this placement site SP. The fuel discharged from the fuel gun FG inserted in the filler port FC is flowed through the filler pipe FP from the filler neck FN to the fuel tank FT an supplied through the check valve TV to the fuel tank FT. The check valve TV serves to prevent the backflow of the fuel from the fuel tank FT to the filler pipe FP. The filler pipe FP may have a serpentine structure at the bending location.

The breather pipe BP has one end connected with the fuel tank FT via the gas release regulating valve BV and the other end connected with a breather port that is protruded from the filler neck FN. The gas release regulating valve BV is a check valve that is opened and closed according to the internal pressure of the fuel tank FT. When the internal pressure of the fuel tank FT is equal to or lower than a predetermined value, the gas release regulating valve BV is closed to block circulation of the air from the fuel tank FT to the filler neck FN. When the internal pressure of the fuel tank FT becomes higher than the predetermined value, the gas release regulating valve BV is opened to allow for circulation of the air from the fuel tank FT to the filler neck FN. The air in the fuel tank FT includes fuel vapor. The fuel vapor is introduced along with the supplied fuel through the filler pipe FP to the fuel tank FT during fueling from the fuel gun FG. Such operation of the gas release regulating valve BV maintains the internal pressure of the fuel tank FT at a predetermined pressure level. The following describes the configuration of main part of the fuel supply apparatus FS in detail.

FIG. 2 is a diagram illustrating a sectional view in the vertical direction of the filler pipe FP of the first embodiment in a peripheral area X of the placement site SP and a plan view of the grid member 10 held at the placement site SP. The sectional view of FIG. 2 shows a section of the grid member 10 taken along a bending line A-A in the plan view of the grid member 10.

As illustrated, the filler pipe FP forms an engagement portion Kr by expanding the diameter at the placement site SP in a partial area of a fuel passage Tr. The grid member 10 is engaged with and held on this engagement portion Kr. The grid member 10 includes an outer body 12, a first grid arm 13, a second grid arm 14, a third grid arm 15, a linkage arm 17, a first inner ring arm 18 and a second inner ring arm 19. The outer body 12 is a band-like curved body engaged with and placed in an engagement portion inner circumferential wall of the engagement portion Kr of the filler pipe FP. In the engaged and held state shown in FIG. 2, the outer body 12 is bent in a ring shape to have a space between both ends of the inner ring arms. Each of the first to third grid arms 13 to 15 is extended inward from the outer body 12. The respective ends of the second grid arm 14 and the third grid arm 15 are linked with each other by the linkage arm 17. The first inner ring arm 18 is arranged to intersect with the second grid arm 14 and the third grid arm 15 and is extended in a curved shape inside of the outer body 12 to have a space from the first grid arm 13. The second inner ring arm 19 is extended from the first grid arm 13 to be located on the extension of the curved shape of the first inner ring arm 18 and have a space from the first inner ring 18 extended from the linkage arm 17. The first grid arm 13 has a convex engagement piece 16 provided on its free end. This engagement piece 16 is engaged with the linkage arm 17 in the engaged and held state shown in FIG. 2. In the state that this grid member 10 is engaged with and held on the engagement portion Kr at the placement site SP as shown in FIG. 2, the inside of the outer body 12 is divided in a grid-like pattern by the first to the third grid arms 13 to 15 and the first and the second inner ring arms 18 and 19. Each of a plurality of openings divided and formed by the grid member 10 has a size that does not allow a small-diameter fuel suction tube ST of about 5φ to pass through. In the state that the grid member 10 is engaged with and held on the engagement portion Kr at the placement site Sp, the grid member 10 accordingly serves as a suction-preventing member to prevent suction of the fuel by the fuel suction tube ST. The grid member 10 for preventing suction of the fuel described above is placed at the placement site SP according to the following procedure.

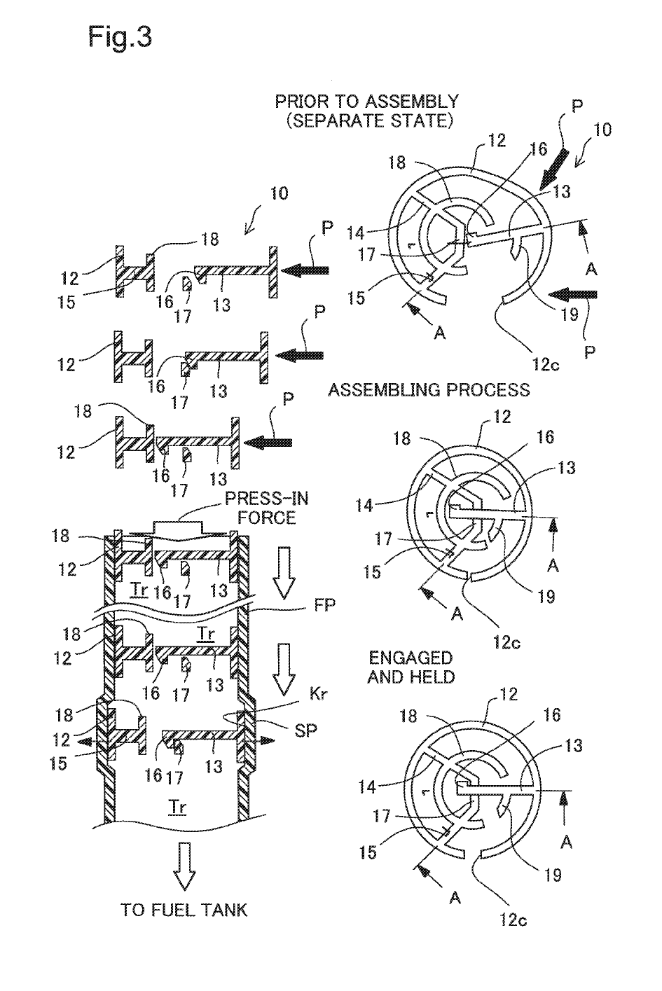

FIG. 3 is a diagram illustrating the shape of the grid member 10 prior to assembly and the state of assembly. The right side of FIG. 3 illustrates a change in shape of the grid member 10 in the plan view in relation to the state of assembly and the left side of FIG. 3 illustrates a change in shape of the grid member 10 in the sectional view taken along the bending line A-A of the plan view in relation to the state of assembly.

In the separate state of the grid member 10 prior to assembly to the filler pipe FP, the second grid arm 14 and the third grid arm 15 linked with each other by the linkage arm 17 and part of the first inner ring arm 18 and part of the outer body 12 surrounded by these two grid arms 14 and 15 have similar configuration to the configuration in the state that the grid member 10 is engaged with and held on the engagement portion Kr at the placement site SP. The engagement piece 16 of the first grid arm 13 is, however, not engaged with the linkage arm 17. The grid member 10 has the expanded diameter as a whole by expanding the first grid arm 13 and part of the outer body 12 linked with the first grid arm 13 from the state that the grid member 10 is engaged with and held on the engagement portion Kr at the placement site SP, such as to have a space 12c between the respective ends of the outer body 12, a space between the first grid arm 13 and the first inner ring arm 18 extended from the second grid arm 14 and a space between the second inner ring arm 19 extended from the first grid arm 13 and the first inner ring arm 18 extended from the third grid arm 15. The grid member 10 is a molded product of for example, a polyamide (PA) such as nylon-12 having oil resistance and is formed to have the elastically deformable outer body 12. The grid member 10 accordingly allows for expansion of the diameter from the configuration in the state engaged with and held on the engagement portion Kr at the placement site SP to the configuration in the separate state and contraction of the diameter from the configuration in the separate state to the configuration in the state engaged with and held on the engagement portion Kr at the placement site SP.

In order to engage and hold this grid member 10 with and on the engagement portion Kr at the placement site SP, a force shown by arrows P is first applied to the diameter-expanded part of the outer body 12 in the separate state of the grid member 10 to contract the diameter of the diameter-expanded part. More specifically, the circumference of the outer body 12 is clamped with a grip tool, a robot hand or the operator's fingers (not shown), and the engagement piece 16 of the first grid arm 13 is placed on the linkage arm 17 to be located close to the first inner ring arm 18. In this state, the grid member 10 has the contracted diameter to substantially eliminate the space 12c of the outer body 12, as shown in the plan view of the grid member 10 in the assembling process. The outer body 12 accordingly has a ring shape having the outer diameter that is equal to or smaller than the inner diameter of the fuel passage Tr of the filler pipe FP The grid member 10 can be inserted in this diameter-contracted state from the opening into the fuel passage Tr of the filler pipe FP. In this diameter-contracted state, the grid member 10 is elastically deformed to have the contracted diameter, so that elastic energy for returning the grid member 10 in the radially outward direction is accumulated in the grid member 10.

When the grid member 10 in the diameter-contracted state is inserted into the fuel passage Tr; the grid member 10 is released from the diameter-contracting force and is elastically deformed to be returned to the configuration in the separate state shown in FIG. 3, so that the outer body 12 is pressed against the inner circumferential wall of the fuel passage Tr. This pressing force causes the grid member 10 to stay at the inserted location. When a force (press-in force) that exceeds the resisting force due to friction by the pressing force is applied in a direction along the fuel passage Tr, the grid member 10 is moved from the opening of the fuel passage Tr along the fuel passage Tr. Accordingly the grid member 10 is configured to allow for insertion into the fuel passage Tr and move along the fuel passage Tr.

After insertion of the grid member 10 into the fuel passage Tr, the grid member 10 continuously receives the press-in force that exceeds the resisting force described above in the direction along the fuel passage Tr in the assembling process. The grid member 10 is accordingly moved along the fuel passage Tr to eventually reach the engagement portion Kr at the placement site SP. This engagement portion Kr is formed in a groove-like shape to have the larger diameter than the diameter of the fuel passage Tr on the upstream side of the placement site SP as described above. The grid member 10 reaching the engagement portion Kr is thus elastically deformed to expand the diameter and increase the space 12c from the state in the assembling process, so that the outer body 12 is pressed against the inner circumferential wall of the engagement portion Kr. In this state, the outer diameter of the outer body 12 is expanded to be larger than the inner diameter of the fuel passage Tr on the downstream side of the engagement portion Kr. This prevents the grid member 10 from being moved toward the fuel tank FT. Accordingly the grid member 10 is engaged with the engagement portion Kr at the placement site SP to stay at the placement site SP in the state that the outer body 12 is pressed against the inner circumferential wall of the engagement portion Kr. After insertion of the grid member 10 in the diameter-contracted state into the fuel passage Tr and move of the grid member 10 along the fuel passage Tr to the engagement portion Kr, the grid member 10 is expanded to be engaged with the engagement portion Kr. This completes insertion of the grid member 10. In the inserted state, the grid member 10 prevents suction of the fuel by the fuel suction tube ST as shown in FIG. 2.

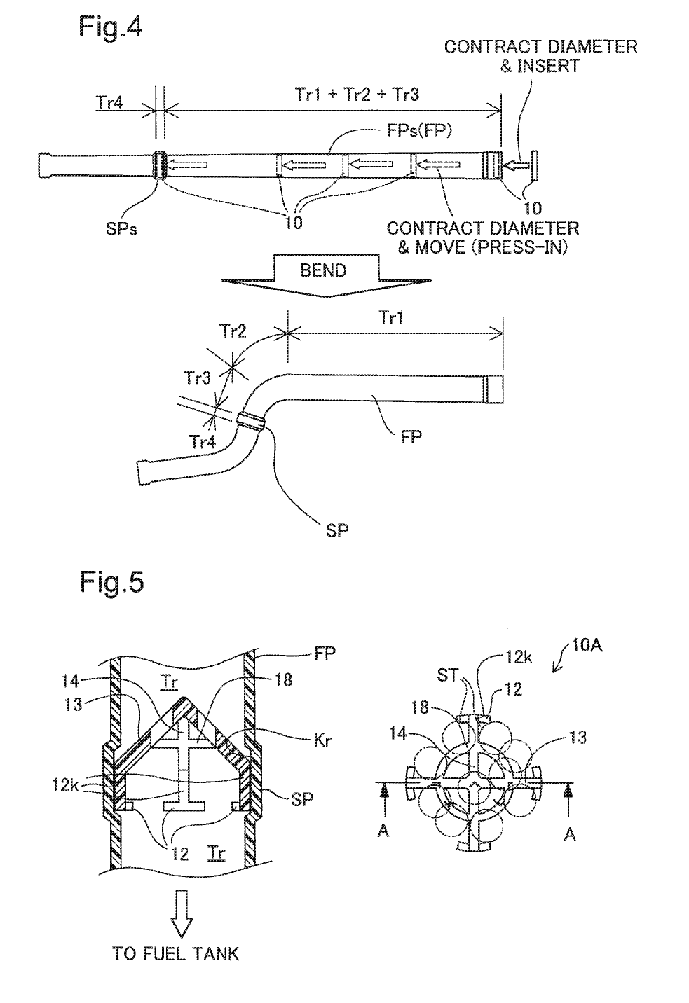

FIG. 4 is a diagram illustrating a procedure of insertion of the grid member 10 into the filler pipe FP. As illustrated, the filler pipe FP and the grid member 10 are provided separately. The filler pipe FP is a straight filler pipe FPs that is die-molded or blow-molded in a straight shape and has a predetermined holding site SPs formed by molding. As described above, the filler pipe FP is arranged along the predetermined route path to form the fuel passage Tr and is connected with the filler neck FN to be mounted to the fuel tank FT. This route path is determined in the design phase. The location occupied by the placement site SP in the filler pipe FP arranged along the predetermined route path is specified by a first path Tr1, a second path Tr2, a third path Tr3 and a fourth path Tr4 from an end of the filler pipe FP along the route path. The placement site SP occupied in the filler pipe FP arranged along the predetermined route path is provided at the holding site SPs of the straight filler pipe FPs. The straight filler pipe FPs has the holding site SPs at a location of the fourth path Tr4 that is away from the end of the straight filler pipe FPs by the sum of the path. lengths of the first path Tr1, the second path Tr2 and the third path Tr3.

As described in FIG. 3, the grid member 10 is inserted in the diameter-contracted state into the straight filler pipe FPs provided as described above or more specifically into the linear fuel passage Tr of the straight filler pipe FPs. The press-in force is then applied to the grid member 10 as described in FIG. 3 to move the grid member 10 along the linear fuel passage Tr of the straight filler pipe FPs to the holding site SPs. The diameter of the grid member 10 is expanded in this holding site SPs, so that the grid member 10 is held at the holding site SPs. The straight filler pipe FPs having the grid member 10 held therein is then heated and bent. This provides the filler pipe FP having the fuel passage Tr arranged from the fuel tank FT along the predetermined route path. The filler pipe FP thus provided is mounted to the fuel tank FT (shown in FIG. 1) of the vehicle (not shown) to feed the fuel supplied from the filler port FC into the fuel tank FT.

As shown in FIG. 3, in the fuel supply apparatus FS of the first embodiment, the grid member 10 inserted in the fuel passage Tr formed by the filler pipe FP is moved along the fuel passage Tr to the placement site SP to be held at the placement site SP. The placement site SP is provided at the higher position in the vertical direction than the ceiling wall FTt of the fuel tank FT as shown in FIG. 1. Even when the fuel tank FT is filled with the fuel, the liquid level of the fuel in the fuel passage Tr is lower than the placement site SP, so that the fuel does not reach the placement site SP in the fuel passage Tr. In the fuel supply apparatus FS of the first embodiment, even when the fuel suction tube ST (shown in FIG. 2) is inserted into the filler pipe FP for the purpose of suction of the fuel, the grid member 10 held at the placement site SP effectively prevents the fuel suction tube ST from reaching the fuel in the fuel passage Tr. This accordingly prevents suction of the fuel with high effectiveness.

In the fuel supply apparatus FS of the first embodiment, the grid member 10 that is to be held at the placement site SP is configured to allow for insertion and move of the grid member 10 from the filler port FC to the placement site SP (as shown in FIG. 3). The placement site SP may be provided at an appropriate location determined in the middle of the fuel passage Tr. In the fuel supply apparatus FS of the first embodiment, the placement site SP may be determined according to the convenience, for example, the design of the vehicle and the arrangement of peripheral devices of the fuel tank FT. The grid member 10 may thus be placed with high flexibility at the placement site SP in the middle of the fuel passage Tr. In the configuration of FIG. 1, the placement site SP is provided at the higher position in the vertical direction than the ceiling wall FTt of the fuel tank FT. According to a modification, the placement site SP may be provided at approximately the same height as the ceiling wall FTt or at a slightly lower position than the ceiling wall FTt. In the configuration of the first embodiment, the grid member 10 is placed in the engagement portion Kr at the placement site SP in the state that the grid member 10 is pressed against the inner circumferential wall of the engagement portion Kr. According to a modification, the grid member 10 may be placed in the engagement portion Kr in the state that the grid member 10 is not pressed against the inner circumferential wall of the engagement portion Kr.

The configuration of the fuel supply apparatus FS of the first embodiment enables the grid member 10 to be held at the placement site SP after being moved along the fuel passage Tr. There is accordingly no need to part the filler pipe FP into sections for the purpose of holding the grid member 10 at the placement site SP. Additionally, there is no need for any additional tubes used for pipe connection at the locations of partition of the filler pipe. The fuel supply apparatus FS of the first embodiment accordingly has no need for connection of the parted sections of the filler pipe using additional tubes and assembly of the grid member. This reduces the man hour and thereby reduces the cost.

In the fuel supply apparatus FS of the first embodiment, the grid member 10 is engaged with the engagement portion Kr formed in the fuel passage Tr at the placement site SP. Accordingly the fuel supply apparatus FS of the first embodiment desirably holds the grid member 10 at the placement site SP with high effectiveness.

In the fuel supply apparatus FS of the first embodiment, the engagement portion Kr at the placement site SP of the filler pipe FP is formed by expanding the diameter of the fuel passage Tr. In the fuel supply apparatus FS of the first embodiment, the grid member 10 configured to increase and contract the diameter is inserted in the diameter-contracted state into the fuel passage Tr and is moved along the fuel passage Tr (as shown in FIG. 3). The diameter of the grid member 10 is then expanded, and the grid member 10 is engaged with the engagement portion Kr. In the fuel supply apparatus FS of the first embodiment, the grid member 10 can be readily held at the placement site Sp by simply moving the grid member 10 to the placement site SP. This configuration also enables the grid member 10 to be more reliably held at the placement site SP.

In order to obtain the fuel supply apparatus FS of the first embodiment, the procedure of the first embodiment inserts the grid member 10 into the fuel passage Tr and moves the grid member 10 along the fuel passage Tr in the straight filler pipe FPs, so as to hold the grid member 10 at the holding site SPs. The procedure then bends the straight filler pipe FPs to provide the fuel passage Tr arranged along the predetermined route path. The manufacturing method of the filler pipe FP of the first embodiment accordingly enhances the workability in holding the grid member 10 in manufacture of the filler pipe FP having the high effectiveness to prevent suction of the fuel by the fuel suction tube ST. This accordingly reduces the man hour and thereby reduces the cost.

### B. Second Embodiment

FIG. 5 is a diagram illustrating a sectional view in the vertical direction of a filler pipe FP of a second embodiment in a peripheral area X of a placement site SP and a plan view of a grid member 10A held at the placement site SP. The sectional view of FIG. 5 shows a section of the grid member 10A taken along a bending line A-A in the plan view of the grid member 10A.

As illustrated, the filler pipe FP forms an engagement portion Kr by expanding the diameter at the placement site SP in a partial area of the fuel passage Tr. The grid member 10A is engaged with and held on this engagement portion Kr. The grid member 10A includes outer bodies 12, a first grid arm 13, a second grid arm 14 and a first inner ring arm 18. The outer bodies 12 are curved bodies engaged with and placed in an engagement portion inner circumferential wall of the engagement portion Kr of the filler pipe FP and are held by flexible arms 12k extended from the first grid arm 13 and the second grid arm 14. The first grid arm 13 and the second grid arm 14 are extended inward from the flexible arms 12k provided to hold the outer bodies 12 and are arranged to intersect with each other at the center of the outer bodies 12 in the plan view. The first grid arm 13 and the second grid arm 14 cooperate with the first inner ring arm 18 to divide the inside of the outer bodies 12 in a grid-like pattern and not to allow the fuel suction tube ST to pass through. In the state that the grid member 10A in the filler pipe FP of the second embodiment is engaged with and held on the engagement portion Kr at the placement site SP, the grid member 10A prevents suction of the fuel by the fuel suction tube ST. The grid member 10A for preventing suction of the fuel described above is placed at the placement site SP according to the following procedure.

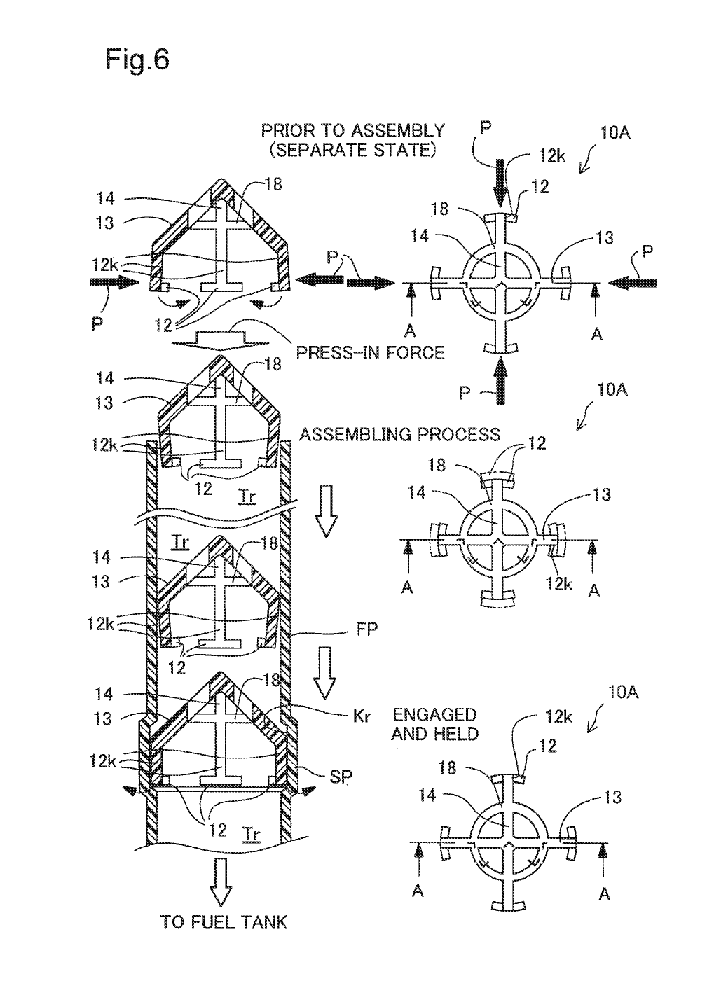

FIG. 6 is a diagram illustrating the shape of the grid member 10A prior to assembly and the state of assembly. The right side of FIG. 6 illustrates a change in shape of the grid member 10A in the plan view in relation to the state of assembly, and the left side of FIG. 6 illustrates a change in shape of the grid member 10A in the sectional view taken along a bending line A-A of the plan view in relation to the state of assembly.

In the grid member 10A, each of the flexible arms 12k is extended and inclined outward about a connection position with the first grid arm 13 or the second grid arm 14 and is configured to be flexible toward the center of the outer bodies 12. In the separate state of the grid member 10A prior to assembly to the filler pipe FP, the outer bodies 12 are held by the flexible arms 12k inclined outward and are expanded from the state that the grid member 10A is engaged with and held on the engagement portion Kr at the placement site SP, so that the grid member 10A has the expanded diameter as a whole. The grid member 10A is a molded product of for example, a polyamide (PA) such as nylon-12 like the grid member 10 described above and is formed to have the elastically deformable flexible arms 12k. The grid member 10A thus also allows for expansion of the diameter from the configuration in the state engaged with and held on the engagement portion Kr at the placement site SP to the configuration in the separate state and contraction of the diameter from the configuration in the separate state to the configuration in the state engaged with and held on the engagement portion Kr at the placement site SP.

In order to engage and hold this grid member 10A with and on the engagement portion Kr at the placement site SP, a force shown by arrows P is first applied to the diameter-expanded part of the outer bodies 12 in the separate state of the grid member 10A to bend the flexible arms 12k inward and contract the diameter of the outer bodies 12. More specifically the flexible arms 12k arranged to face each other are clamped with a grip tool, a robot hand or the operator's fingers (not shown) to be bent inward. When the diameter of the grid member 10A is contracted by bending the flexible arms 12k, the outer diameter of the outer bodies 12 becomes equal to or smaller than the inner diameter of the fuel passage Tr of the filler pipe FP The grid member 10A can be inserted in this diameter-contracted state from the opening into the fuel passage Tr of the filler pipe FP.

When the grid member 10A in the diameter-contracted state is inserted into the fuel passage Tr the grid member 10A is released from the diameter-contracting force and the flexible arms 12k are elastically deformed to be returned to the configuration in the separate state shown in FIG. 5, so that the outer bodies 12 are pressed against the inner circumferential wall of the fuel passage Tr. This pressing force causes the grid member 10A to stay at the inserted location. When a force (press-in force) that exceeds the pressing force is applied in a direction along the fuel passage Tr, the grid member 10A is moved from the opening of the fuel passage Tr along the fuel passage Tr. Accordingly the grid member 10A is also configured to allow for insertion into the fuel passage Tr and move along the fuel passage Tr.

After insertion of the grid member 10A into the fuel passage Tr, the grid member 10A continuously receives the press-in force that exceeds the pressing force described above in the direction along the fuel passage Tr in the assembling process. The grid member 10A is accordingly moved along the fuel passage Tr to eventually reach the engagement portion Kr at the placement site SP. This engagement portion Kr is formed to have the larger diameter than the diameter of the fuel passage Tr on the upstream side of the placement site SP as described above. In the grid member 10A reaching the engagement portion Kr, the flexible arms 12k are elastically deformed to open wider than the state in the assembling process and thereby increase the diameter of the outer bodies 12, so that the outer bodies 12 are pressed against the inner circumferential wall of the engagement portion Kr. The press-in force applied in the assembling process is released in this state, so that the grid member 10A is engaged with the engagement portion Kr at the placement site SP in the state that the outer bodies 12 are pressed against the inner circumferential wall of the engagement portion Kr, so as to stay at the placement portion SP. After insertion of the grid member 10A in the diameter-contracted state into the fuel passage Tr and move of the grid member 10A along the fuel passage Tr to the engagement portion Kr, the grid member 10A is expanded to be engaged with the engagement portion Kr. This completes insertion of the grid member 10A. In the inserted state, the grid member 10.A prevents suction of the fuel by the fuel suction tube ST as shown in FIG. 5. The grid member 10A is inserted and moved in a straight filler pipe FPs like the grid member 10 described above, and the filler pipe FP is provided by bending the straight filler pipe FPs.

A fuel supply apparatus FS using the filler pipe FP in which the grid member 10A of the second embodiment described above is held has similar advantageous effects as those described above, for example, preventing suction of the fuel with high effectiveness and reducing the man hour.

### C. Third Embodiment

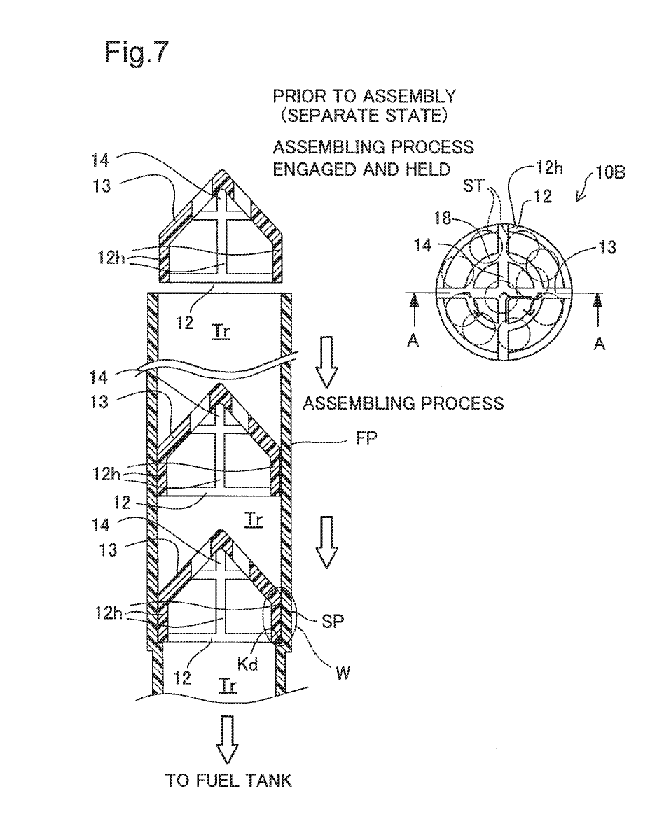

FIG. 7 is a diagram illustrating the shape of a grid member 10B prior to assembly and the state of assembly according to a third embodiment. The right side of FIG. 7 illustrates a change in shape of the grid member 10B in the plan view in relation to the state of assembly, and the left side of FIG. 7 illustrates a change in shape of the grid member 10B in the sectional view taken along a bending line A-A of the plan view in relation to the state of assembly.

As illustrated, a filler pipe FP of the third embodiment has a step Kd at a placement portion SP in the middle of a fuel passage Tr. Formation of this step Kd reduces the diameter of the fuel passage Tr on the downstream side of the step Kd. The grid member 10B is engaged with and held on this step Kd. The position where the step Kd is formed is a higher position in the vertical direction than the ceiling wall FTt of the fuel tank FT. According to a modification, the step Kd may be formed by bending part of the fuel passage Tr, and the upstream side and the downstream side of the step Kd may be formed to provide the fuel passage Tr of the identical inner diameter.

The grid member 10B includes an outer body 12, a first grid arm 13, a second grid arm 14 and a first inner ring arm 18. The outer body 12 is a ring-shaped body that is joined with and placed in an inner circumferential wall of the fuel passage Tr on the upstream side of the step Kd and is held by holding arms 12h extended from the first grid arm 13 and the second grid arm 14. The first grid arm 13 and the second grid arm 14 are extended inward from the holding arms 12h provided to hold the outer body 12 and are arranged to intersect with each other at the center of the outer body 12 in the plan view. The first grid arm 13 and the second grid arm 14 cooperate with the first inner ring arm 18 to divide the inside of the outer body 12 in a grid-like pattern and not to allow the fuel suction tube ST to pass through. In the state that the grid member 10B in the filler pipe FP of the third embodiment is engaged with and held on the step Kd located at the height of the placement site SP as described above, the grid member 10B prevents suction of the fuel by the fuel suction tube ST. The grid member 10B for preventing suction of the fuel described above is placed at the placement site SP according to the following procedure.

Like the grid member 10 described above, the grid member 10B is a molded product of for example, a polyamide (PA) such as nylon-12. In the separate state of the grid member 10B, the outer diameter of the outer body 12 is made slightly smaller than the inner diameter of the fuel passage Tr on the upstream side of the step Kd. Accordingly the grid member 10B is clamped with a grip tool, a robot hand or the operator's fingers (not shown) to be inserted into the fuel passage Tr. After release from the clamp, the grid member 10B is moved from the opening of the fuel passage Tr along the fuel passage Tr by its own weight or an auxiliary press-in force in the direction of the fuel passage Tr. Accordingly the grid member 10B is also configured to allow for insertion into the fuel passage Tr and move along the fuel passage Tr.

After insertion into the fuel passage Tr, the grid member 10B is moved along the fuel passage Tr to eventually reach the step Kd and is held on the step Kd at the placement site DP. In this state, the grid member 10B is irradiated with laser beam from outside of the filler pipe FP to be thermally welded, so that the outer surface of the outer body 12 that adjoins to the inner wall of the fuel passage Tr is thermally welded to the fuel passage Tr or more specifically to the filler pipe FP. This thermally welded part W includes the outer surface of the outer body 12 and the outer surface of the holding arms 12h. The grid member 10B is held on and fixed to the step Kd by such thermal welding, so as to prevent suction of the fuel by the fuel suction tube ST as shown in FIG. 7. The grid member 10B is inserted and moved in a straight filler pipe FPs like the grid member 10 described above, and the filler pipe FP is provided by bending the straight filler pipe FPs.

A fuel supply apparatus FS using the filler pipe FP in which the grid member 10B of the third embodiment described above is held has similar advantageous effects as those described above, for example, preventing suction of the fuel with high effectiveness.

### D. Fourth Embodiment

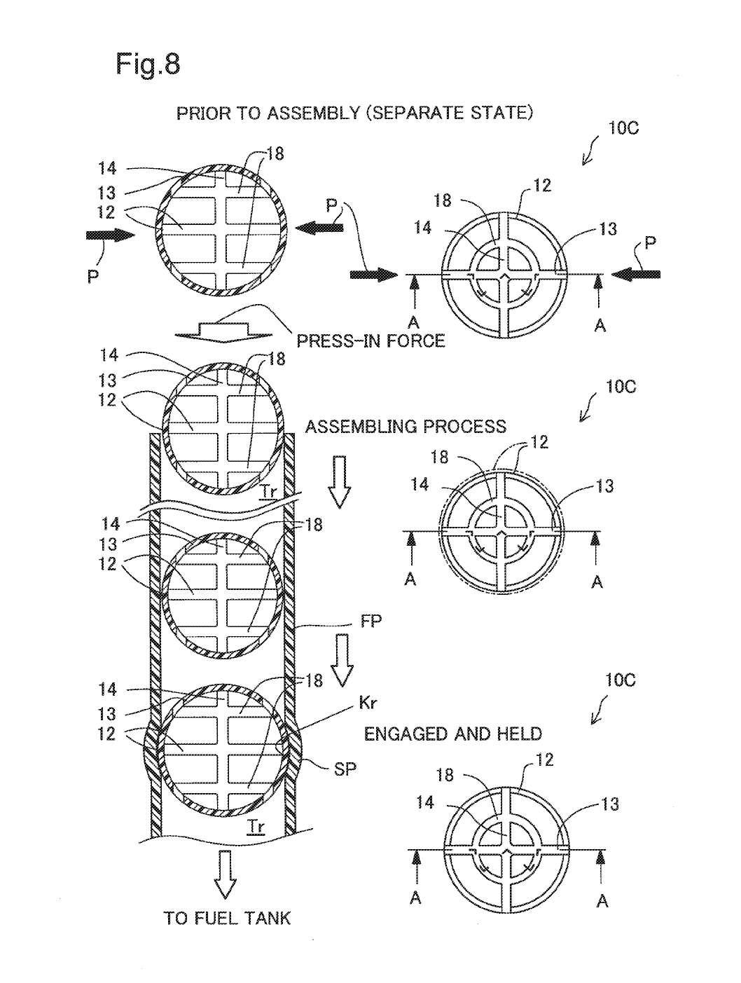

FIG. 8 is a diagram illustrating the shape of a grid member 10G prior to assembly and the state of assembly according to a fourth embodiment. The right side of FIG. 8 illustrates a change in shape of the grid member 10G in the plan view in relation to the state of assembly, and the left side of FIG. 8 illustrates a change in shape of the grid member 10G in the sectional view taken along a bending line A-A of the plan view in relation to the state of assembly.

As illustrated, a filler pipe FP of the fourth embodiment has an engagement portion Kr that is expanded in an arc shape at a placement site SP in the middle of a fuel passage Tr. The grid member 10G in a spherical outer shape is held on this engagement portion Kr.

The grid member 10G includes an outer body 12, a first grid arm 13, a second grid arm 14 and a first inner ring arm 18. The outer body 12, the first grid arm 13 and the second grid arm 14 are all formed in band-like ring shapes to be engaged with one another and form the grid member 10G in a spherical shape. The first inner ring arm 18 is arranged to intersect with the first grid arm 13 and the second grid arm 14, so as to divide the inside of the outer body 12 in a grid-like pattern and not to allow the fuel suction tube ST to pass through. The outer body 12, the first grid arm 13 and the second grid arm 14 are all formed to be elastically deformable. The grid member 10G in the spherical shape is thus configured to be deformable to an elliptical shape (by contraction of the diameter) and allow for insertion into the fuel passage Tr and move along the fuel passage Tr to the engagement portion Kr.

In order to engage and hold this grid member 10G with and on the engagement portion Kr at the placement site Sp, a force shown by arrows P is first applied to the outer body 12 in the separate state of the grid member 10C. This deforms the grid member 10G to an elliptical shape (by contraction of the diameter). More specifically the first grid arm 13 or the second grid arm 14 is clamped with a grip tool, a robot hand or the operator's fingers (not shown) to be bent to an elliptical shape. When the diameter of the grid member 10G is contracted by bending the first grid arm 13 or the second grid arm 14, the outer diameter of the outer body 12 becomes equal to or smaller than the inner diameter of the fuel passage Tr of the filler pipe FP. The grid member 10G is inserted in this diameter-contracted state from the opening of the fuel passage Tr into the fuel passage Tr of the filler pipe FP and is then pressed in and moved along the fuel passage Tr to the engagement portion Kr by the press-in force. When the press-in force is released after completion of the move of the grid member 10G to the engagement portion Kr, the grid member 10G is expanded to be returned to the spherical shape in the separate state and is thereby held on the engagement portion Kr in the arc shape.

A fuel supply apparatus FS using the filler pipe FP in which the grid member 10C of the fourth embodiment described above is held has similar advantageous effects as those described above, for example, preventing suction of the fuel with high effectiveness.

In the grid member 10C of the fourth embodiment described above, the first grid arm 13 and the second grid arm 14 are formed in the band-like ring shape like the outer body 12. The first grid arm 13 or the second grid arm 14 may thus be engaged with the engagement portion Kr, instead of the outer body 12. This configuration of the fourth embodiment increases the flexibility of the location of the grid member 10C around the vertical circumference and the horizontal circumference in the attitude during insertion of the grid member 10C. This facilitates the operation for insertion of the grid member 10C.

### E. Modifications

The invention is not limited to any of the embodiments described above but may be implemented by a diversity of other configurations without departing from the scope of the invention. For example, the technical features of any of the embodiments corresponding to the technical features of each of the aspects described in SUMMARY may be replaced or combined appropriately; in order to solve part or all of the problems described above. Any of the technical features may be omitted appropriately unless the technical feature is described as essential herein.

In the embodiments described above, the grid member 10, 10A or 10B is assembled to the straight filler pipe FPs. According to a modification, the grid member 10, 10A or 10B may be inserted in a filler pipe FP that is curved in advance along a predetermined route path and may be moved along the predetermined route path to the placement site SP.

The thermal welding technique employed for the grid member 10B of the third embodiment may also be employed for the grid member 10, 10A or 10C engaged with and held on the engagement portion Kr in the first embodiment, the second embodiment or the fourth embodiment.

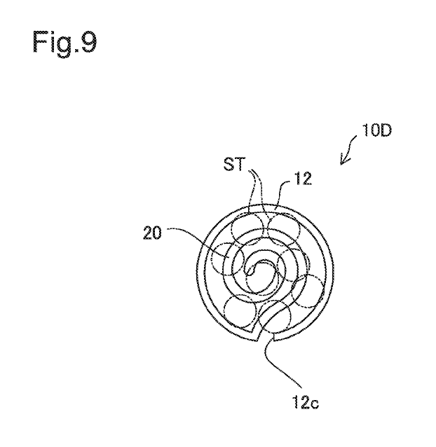

In the grid member 10, 10A, 10B and 10C of the respective embodiments described above, the first inner ring arm 18 is arranged to intersect with the first grid arm 13 and the second grid arm 14 that are arranged to intersect with each other, so as to provide the suction-preventing member that divides and forms openings in a grid-like pattern and not to allow the fuel suction tube ST to pass through. The suction-preventing member may however, have another configuration. For example, a suction-preventing member may be configured by providing an outer body 12 that is configured to be expandable and contractable and exclude the first inner ring arm 18 and the second inner ring arm 19 from the configuration shown in FIG. 3 and disposing a member separate from this outer body 12, for example, a grid-forming member, an opening-forming member having an array of a plurality of openings in rectangular shapes or a wire mesh body having a cone-shaped wire mesh held at a bottom face of the cone by a ring, to be laid over the outer body 12 engaged with and held on the engagement portion Kr. FIG. 9 is a plan view schematically illustrating a grid member 10D provided as a suction-preventing member in a spiral shape according to a modification. The grid member 10D of this modification has a space 12c to hold a spiral inner ring arm 20 on an expandable and contractable outer body 12. The presence of this spiral inner ring arm 20 more effectively prevents the fuel suction tube ST from passing through.

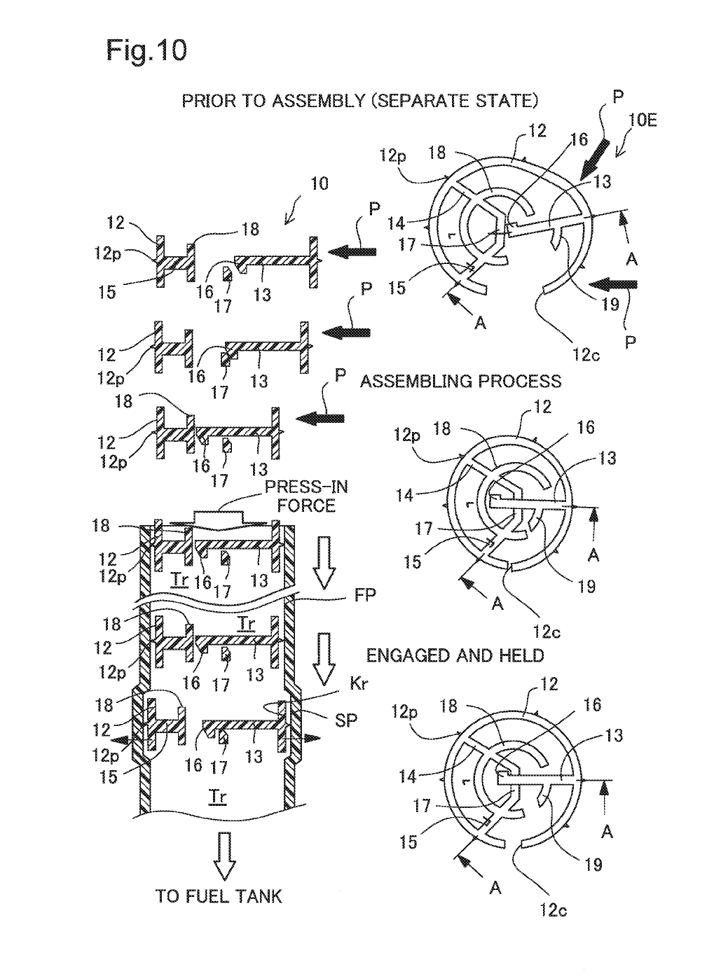

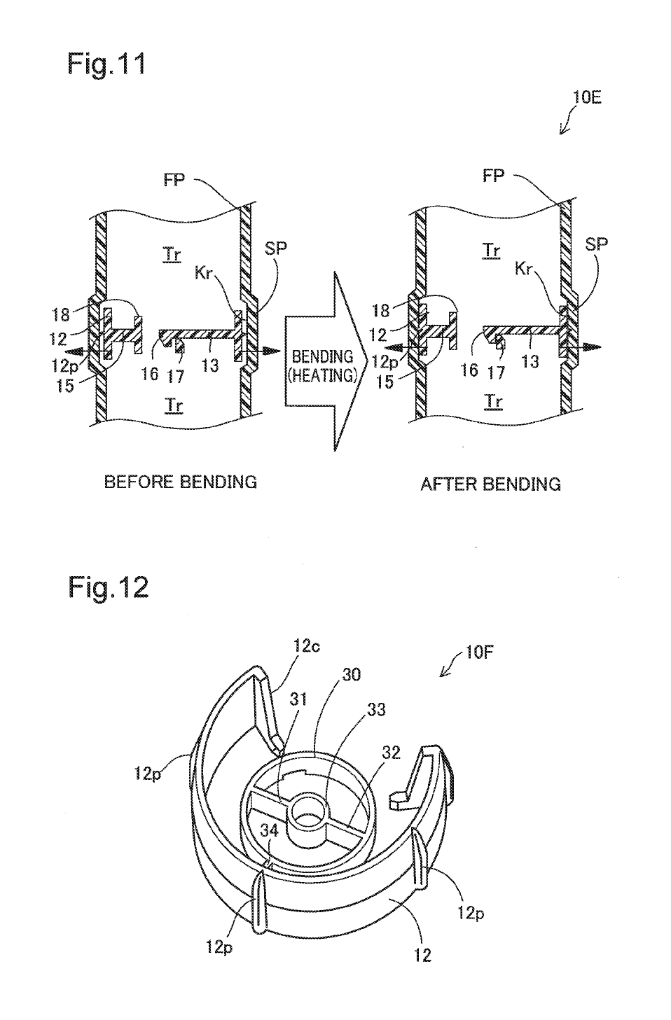

FIG. 10 is a diagram illustrating another grid member 10E prior to assembly that employs a different configuration for engagement at a placement site SP and the state of assembly according to a modification. FIG. 11 is a diagram illustrating engagement of the grid member 10E at the placement site SP after bending a filler pipe FP. This grid member 10E differs from the grid member 10 of the first embodiment only by the presence of engagement projections 12p arranged along the outer circumference of the outer body 12. The grid member 10E is inserted in and assembled to a fuel passage Tr, like the grid member 10. In the process of assembly of the grid member 10E, the engagement projections 12p are pressed against the inner circumferential wall of the fuel passage Tr. When the grid member 10E reaches the placement site SP, the diameter of an outer body 12 is expanded to press the engagement projections 12p against the inner circumferential wall of an engagement portion Kr and keep the grid member 10E at the placement site SP. In a subsequent bending process, the filler pipe FP is heated, and the inner circumferential wall of the engagement portion Kr in the filler pipe FP is softened by the heat. As shown in FIG. 11, the diameter of the outer body 12 is accordingly expanded to make the engagement projections 12p embedded in the inner circumferential wall of the filler pipe FP, so that the grid member 10E is engaged at the placement site SP. This configuration of the grid member 10E ensures the firmer engagement of the grid member 10E at the placement site SP. According to another modification, instead of providing the engagement projections 12p, the outer body 12 may be configured to have the rough outer circumferential wall surface, in order to increase the contact surface area of the outer circumferential wall of the outer body 12 with the inner circumferential wall of the engagement portion Kr in the filler pipe FP softened by the heat in the bending process. A mold employed to produce the grid member 10 may be provided to have a rough surface, in order to provide the rough surface of the outer body 12.

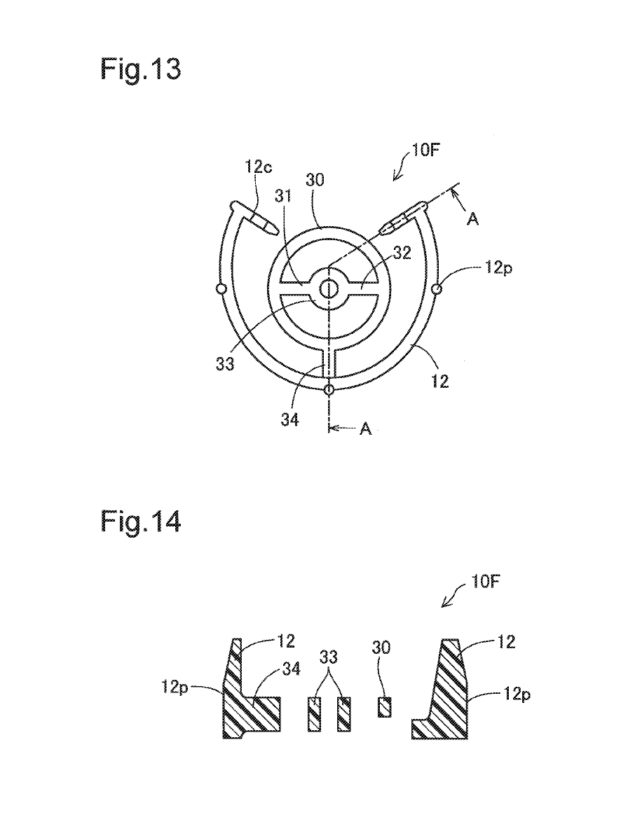

FIG. 12 is a perspective view illustrating a grid member 10F prior to assembly according to a first modification. FIG. 13 is a diagram illustrating a plan view of the grid member 10F shown in FIG. 12. FIG. 14 s a diagram illustrating a sectional view of the grid member 10F taken along a bending line A-A of FIG. 13.

The grid member 10F (shown in FIG. 12) includes an outer body 12, an inner body 30, a first arm 31, a second arm 32, an inner ring arm 33 and a linkage arm 34 (shown in FIG. 13). The grid member 10F is a molded product of for example, a polyamide (PA) such as nylon-12 having oil resistance and is formed to have the elastically deformable outer body 12. Like the grid member 10E, the grid member 10F is a ring-shaped curved body to be engaged with a placement site SP in a fuel passage Tr. A space 12c is provided between respective ends of the outer body 12 along the curved direction. The outer body 12 is elastically deformed to increase and decrease this space 12c, so as to be expanded and contracted. Elastic deformation of the outer body 12 contracts the outer body 12 to such a shape that allows for insertion from the filler port FC to the placement site SE The outer diameter of the outer body 12 prior to assembly to the fuel passage Tr is larger than the inner diameter of the fuel passage Tr including an engagement portion Kr. As shown in FIGS. 12 to 14, the outer body 12 has engagement projections 12p provided on the outer circumferential surface, like the grid member 10E shown in FIG. 10. The grid member 10F may however, not necessarily have the engagement projections 12p on the outer body 12.

The inner body 30 is a ring-shaped member located inside of the outer body 12. The inner body 30 is linked with the outer body 12 by the linkage arm 34 as shown in FIG. 13. The inner ring arm 33 is a ring-shaped member located inside of the ring-shaped inner body 30. The first arm 31 has one end connected with the inner circumferential surface of the inner body 30 and the other end connected with the outer circumferential surface of the inner ring arm 33. The second arm 32 is located on the opposite side to the first arm 31 across the inner ring arm 33. The second arm 32 has one end connected with the inner circumferential surface of the inner body 30 and the other end connected with the outer circumferential surface of the inner ring arm 33. The inner body 30, the first arm 31, the second arm 32 and the inner ring arm 33 are arranged to divide and form a plurality of openings (inner openings) in a grid-like pattern. In the state that the grid member 10F is assembled to the fuel passage Tr, all the plurality of inner openings and the space between the outer body 12 and the inner body 30 in the radial direction of the outer body 12 are configured to be smaller than the diameter of the fuel suction tithe ST. This configuration prevents the fuel suction tube ST from passing through the grid member 10F.

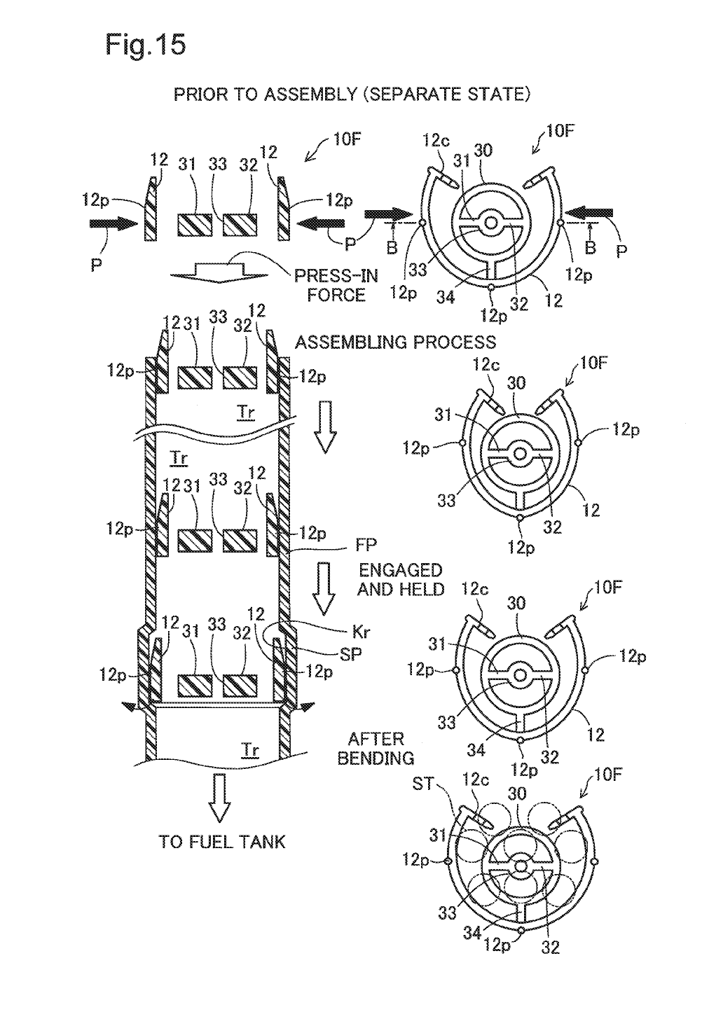

FIG. 15 is a diagram illustrating the shape of the grid member 10F prior to assembly and the state of assembly. The right side of FIG. 15 illustrates a change in shape of the grid member 10F in the plan view in relation to the state of assembly and the left side of FIG. 15 illustrates a change in shape of the grid member 10F in the sectional view taken along a bending line B-B of the plan view in relation to the state of assembly

In order to engage and hold this grid member 10F with and on the engagement portion Kr at the placement site SP, a force shown by arrows P is first applied to the outer body 12 to decrease the space 12c in the separate state prior to assembly of the grid member 10F. More specifically, the force is applied to the outer body 12 to decrease the space 12c, such that the outer diameter of the grid member 10F becomes equal to or smaller than the inner diameter of the fuel passage Tr of the filler pipe FP. The outer body 12 is accordingly deformed to an elliptical shape (by contraction of the diameter) to be inserted into the fuel passage Tr and moved along the fuel passage Tr to the engagement portion Kr. In order to contract the diameter of the outer body 12, the outer body 12 may be clamped with a grip tool, a robot hand or the operator's fingers (not shown) to be bent to an elliptical shape.

The grid member 10F is inserted in this diameter-contracted state from the opening of the fuel passage Tr into the fuel passage Tr. After being inserted, the grid member 10F is pressed in and moved to the engagement portion Kr by the press-in force. The press-in force is released after completion of the move of the grid member 10IF to the engagement portion Kr. When the grid member 10F reaches the engagement portion Kr having the larger diameter than the diameters of the surrounding portions, the outer diameter 12 is expanded by the elastic force. This presses the engagement projections 12p against the inner circumferential wall of the engagement portion Kr and keeps the grid member 10F at the engagement portion Kr. In a subsequent bending process, the filler pipe FP is heated, and the inner circumferential wall of the fuel passage Tr at the engagement portion Kr is softened by the heat. This expands the diameter of the outer body 12 to make the engagement projections 12p embedded in the inner circumferential wall of the engagement portion Kr, like the grid member 10E shown in FIG. 11. Expanding the diameter of the outer body 12 ensures the firmer engagement of the grid member 10F at the placement site SP. In the state that the grid member 10F is inserted and assembled to the engagement portion Kr at the placement site SP, the first arm 31, the second arm 32, the inner ring arm 33 and the inner body 30 serve to divide the inside of the outer body 12 and form openings having sizes that do not allow the fuel suction tube ST to pass through.

A fuel supply apparatus FS using the filler pipe FP in which the grid member 10F of the first modification described above is held has similar advantageous effects as those described above, for example, preventing suction of the fuel with high effectiveness.

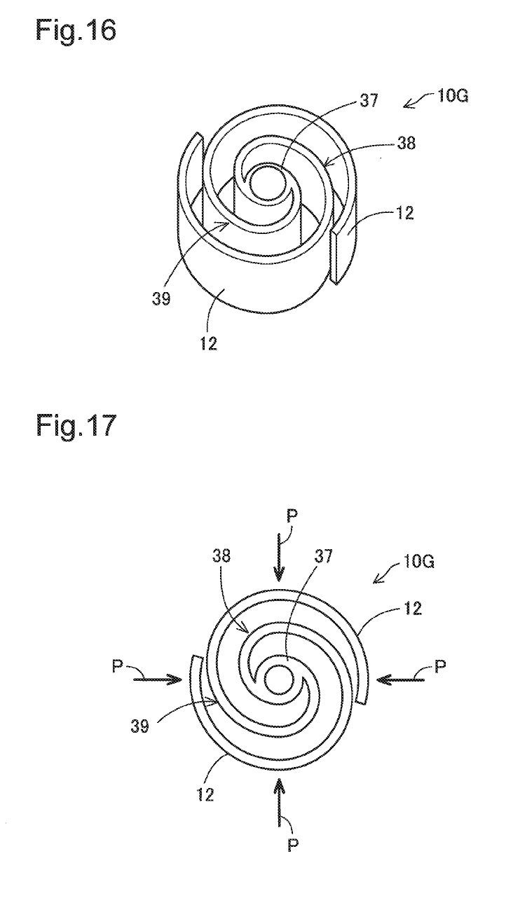

FIG. 16 is a perspective view illustrating a suction-preventing member 10G prior to assembly according to a second modification. FIG. 17 is a diagram illustrating a plan view of the suction-preventing member 10G prior to assembly. Like the grid member 10, the suction-preventing member 10G is a molded product of for example, a polyamide. The suction-preventing member 10G includes a core body 37, a first spiral body 38 and a second spiral body 39. The core body 37 is a tubular member. The core body 37 has the inner diameter that is smaller than the outer diameter of the fuel suction tube ST. The core body 37 may be a solid columnar member. The first spiral body 38 is connected with the outer circumferential surface of the core body 37 and is spiraled about the core body 37. The second spiral body 39 is connected with a different portion of the outer circumferential surface of the core body 37 that is different from the portion connected with the first spiral body 38 and is spiraled about the core body 37. The first spiral body 38 and the second spiral body 39 provide an outer body 12 that is to be engaged with the inner circumferential wall of an engagement portion Kr (for example, shown in FIG. 8). The first spiral body 38 and the second spiral body 39 may be elastically deformed to increase and decrease a space between the first spiral body 38 and the second spiral body 39 in the radial direction of the outer body 12 and thereby expand and contract the diameter of the outer body 12. For example, the diameter of the outer body 12 may be contracted by applying a force shown by arrows P in FIG. 17 to the outer body 12. The suction-preventing member 10G is contracted to such a shape that allows for insertion from the filler port FC to the placement site SP. In the state that the suction-preventing member 10G is assembled to the fuel passage Tr, the space between the first spiral body 38 and the second spiral body 39 in the radial direction of the outer body 12 is smaller than the diameter of the fuel suction tube ST. This configuration prevents the fuel suction tube ST from passing through this space. The outer body 12 may have engagement projections 12p (shown in FIG. 10) on the outer circumferential surface.

A fuel supply apparatus FS using the filler pipe FP in which the suction-preventing member 10G of the second modification described above is held has similar advantageous effects as those described above, for example, preventing suction of the fuel with high effectiveness.

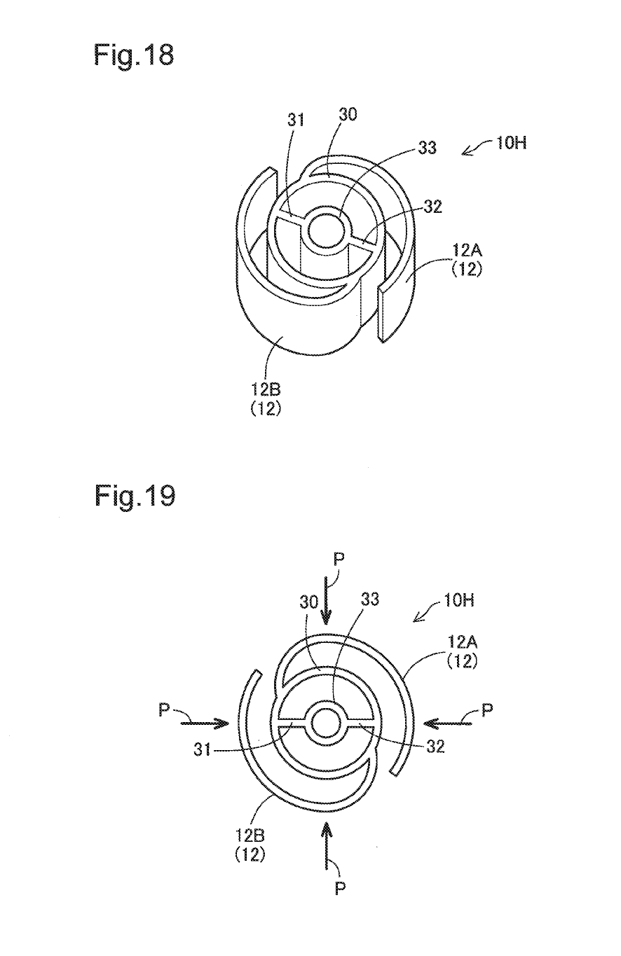

FIG. 18 is a perspective view illustrating a grid member 10H prior to assembly according to a third modification. FIG. 19 is a diagram illustrating a plan view of the grid member 10H prior to assembly. Like the grid member 10, the grid member 10H is a molded product of, for example, a polyamide. The grid member 10H includes an outer body 12, an inner body 30, a first arm 31, a second arm 32 and an inner ring arm 33. The inner body 30, the first arm 31, the second arm 32 and the inner ring arm 33 differ from the inner body 30, the first arm 31, the second arm 32 and the inner ring arm 33 of the grid member 10F only by the loner length along the route path of the fuel passage Tr.

The outer body 12 consists of a first curved body 12A and a second curved body 12B. The first curved body 12A is extended to be curved from the outer circumferential surface of the inner body 30. The second curved body 12B is extended to be curved from a different portion of the outer circumferential surface of the inner body 30 that is different from the portion connected with the first curved body 12A. The first curved body 12A and the second curved body 12B may be elastically deformed to increase and decrease a space between the outer body 12 and the inner body 30 in the radial direction of the outer body 12 and thereby expand and contract the diameter of the outer body 12. For example, the diameter of the outer body 12 may be contracted by applying a force shown by arrows P in FIG. 19 to the outer body 12. The grid member 10H is contracted to such a shape that allows for insertion from the filler port FC to the placement site SP. In the state that the grid member 10H is assembled to the fuel passage Tr, the space between the outer body 12 and the inner body 30 in the radial direction of the outer body 12 is smaller than the diameter of the fuel suction tube ST. A plurality of openings (inner openings) divided and formed in a grid-like pattern by the inner body 30, the first arm 31, the second arm 32 and the inner ring arm 33 are smaller than the diameter of the fuel suction tube ST. This configuration prevents the fuel suction tube ST from passing through the grid member 10H. The outer body 12 may have engagement projections 12p (shown in FIG. 10) on the outer circumferential surface.

A fuel supply apparatus FS using the filler pipe FP in which the grid member 10H, of the third modification described above is held has similar advantageous effects as those described above, for example, preventing suction of the fuel with high effectiveness.

In the embodiment described above, the placement site SP is located at the higher position in the vertical direction than the ceiling wall FTt of the fuel tank FT (as shown in FIG. 1). In a configuration that the highest liquid level of the fuel in the fuel tank FT is determined by a member mounted to the ceiling wall FTt, for example, the gas release regulating valve BV, the placement site SP may be located at a higher position in the vertical direction than the highest liquid level of the fuel determined by this member. This modification also prevents suction of the fuel with high effectiveness.

In the embodiments described above, the grid member 10 is made of a resin. According to a modification, a shape-memory alloy that changes its configuration between low temperature and high temperature may be employed, for example, for the grid member 10A shown in FIG. 6. The flexible arms 12k may be located at the diameter contracting position at low temperature and may be located at the diameter expanding position at high temperature. The filler pipe FP is also not limited to the resin pipe but may be a metal pipe.

What is claimed is:

1. A fuel supply apparatus, comprising;
a filler pipe configured to feed a fuel supplied from a filler port to a fuel tank, the filler pipe forming a fuel passage; and
a suction-preventing member held at a placement site in the middle of the fuel passage, the suction-preventing member configured to prevent suction of the fuel, wherein
the suction-preventing member is in a shape that allows for insertion from the filler port along the fuel passage to the placement site.

2. The fuel supply apparatus according to claim 1,
wherein the placement site is provided at a higher position in a vertical direction than a ceiling wall of the fuel tank.

3. The fuel supply apparatus according to claim 1,
wherein the suction-preventing member is engaged with an engagement portion provided in the fuel passage at the placement site.

4. The fuel supply apparatus according to claim 3,
wherein the filler pipe includes the engagement portion at the placement site as a diameter-expanding portion of the fuel passage, and
the suction-preventing member configured to be expandable and contractable is inserted in a diameter-contracted state from the filler port to the placement site and is expanded after insertion to the engagement portion to be engaged with the engagement portion.

5. The fuel supply apparatus according to claim 3,
wherein the suction-preventing member is engaged with the engagement portion and is thermally welded to the filler piper.

6. The fuel supply apparatus according to claim 1,
wherein the suction-preventing member is a grid member that is configured to divide and form a plurality of openings in a grid-like pattern.

7. The fuel supply apparatus according to claim 4,
wherein the suction-preventing member is a grid member that is configured to divide and form a plurality of openings in a grid-like pattern.

8. The fuel supply apparatus according to claim 5,
wherein the suction-preventing member is a grid member that is configured to divide and form a plurality of openings in a grid-like pattern.

9. A manufacturing method of a filler pipe that is configured to feed a fuel supplied from a filler port to a fuel tank, the manufacturing method comprising:
(a) providing a suction-preventing member that is placed in a fuel passage formed by the filler pipe and is configured to prevent suction of the fuel, in such a shape that allows for insertion from the filler port to a placement site in the middle of the fuel passage;
(b) inserting the provided suction-preventing member into the fuel passage of the filler pipe provided in a straight shape;
(c) moving the inserted suction-preventing member along the fuel passage of the filler pipe in the straight shape and holding the suction-preventing member in the fuel passage at a predetermined holding site; and
(d) bending the filler pipe in the straight shape with the suction-preventing member held therein to provide the fuel passage along a predetermined route path from the fuel tank, wherein
the (c) comprises providing the holding site in the filler pipe in the straight shape, as the placement site in a state that the bent filler pipe is mounted to the fuel tank along the predetermined route path, and holding the suction-preventing member in the fuel passage at the holding site provided as the placement site.

10. The manufacturing method of the filler pipe according to claim 9,
wherein the (c) comprises providing the holding site in the filler pipe in the straight shape, as the placement site that is located at a higher position in a vertical direction than a ceiling wall of the fuel tank in the state that the bent filler pipe is mounted to the fuel tank along the predetermined route path.
